(19) United States
(12) Patent Application Publication
(10) Pub. No.: US 2004/0260979 A1
(43) Pub. Date: Dec. 23, 2004

(54) Information mining system

(76) Inventor: Hiroyuki Kumai, Kunitachi (JP)

Correspondence Address: ANTONELLI, TERRY, STOUT & KRAUS, LLP, 1300 NORTH SEVENTEENTH STREET, SUITE 1800, ARLINGTON, VA, 22209-9889, US

(21) Appl. No.: 10/790,129

(22) Filed: Mar. 2, 2004

(30) Foreign Application Priority Data
Jun. 4, 2003 (JP) 2003-159274

(51) Int. Cl. H02H 3/05

(52) U.S. Cl. 714/37

(57) ABSTRACT

This invention relates to an information mining system capable of mining data stored in a database in a high efficiency. The information mining system includes an operation history data holding unit for recording both an operation history of the analyzing tool carried out in the past in the analyzing operation, and an operation history of the analyzing tool; and a history comparing unit for judging whether or not the operation history is resembled to the operation history of the analyzing tool, and operated in such a manner that when the history comparing unit judges that the operation history of the analyzing tool is resembled to a portion of the operation history of the analyzing tool, the history comparing unit notifies the partial resemblance of the operation history with respect to the analyzing tool.

The present application claims priority from Japanese application JP 2003-159274 filed on Jun. 4, 2003, the content of which is hereby incorporated by reference into this application.

### BACKGROUND OF THE INVENTION

1. Field of the Invention

The present invention generally relates to an information mining system. More specifically, the present invention is directed to an information mining system, an information mining terminal, and a program, capable of mining information in a high efficiency by analyzers.

2. Description of the Related Art

Very recently, since information stored in firms has been processed in electronic data forms, and also, large-scale database constructing methods have been utilized among which a data warehouse constructing method is typically known, large numbers of electronically-processed information such as numeral values, texts, and drawings have been stored in these firms. In order to reflect large-scale databases containing this stored information onto business results of firms, a large number of firms are gradually conducting such management methods as CRM (Customer Relationship Management) and SFA (Sales Force Automation).

As methods capable of extracting useful knowledge and novel rules from these large amounts of the above-described information, a specific attention has been so far paid to information mining techniques.

As this information mining technique, for instance, there is known a data mining technique capable of acquiring quantitative knowledge. Concretely speaking, for example, JP-A-11-15842 describes the below-mentioned data mining technique. That is, the correlative rule producing means produces the correlative rule file based upon the content of the database, and then, outputs this correlative rule file. The evaluation scale designating means outputs the evaluation scale file based upon the evaluation scale designated by the user. The correlative rule evaluating means calculates the evaluation value based upon the evaluation scale file, and updates the information related to the value of the correlative rule contained in the correlative rule file. The execution result display means displays the value information of the correlative rule which has been again evaluated based upon the correlative rule file, and displays the correlative rule after the correlative rule to be displayed has been restrict-processed. As a result, the evaluation scales as to the correlative rules can be set which are different from each other with respect to use purposes of users. Accordingly, the users can easily perform such works capable of finding out the effective correlative rules which can satisfy the requirements of these users from a large amount of correlative rules which have been extracted by executing the data mining method.

Also, as the information mining technique, a text mining method capable of acquiring qualitative knowledge is known. Concretely speaking, for example, JP-A-2001-84250 describes such a text mining method. That is, the language feature analyzing apparatus forms the field-dependent dictionary from the document data in order to improve the analysis precision of the language analyzing apparatus; the language analyzing apparatus forms the structural sentence trees by considering both the co-occurrence relationship and the correlative relationship; and then, since the pattern extracting apparatus employs this structural sentence tree, this pattern extracting apparatus properly extracts/outputs the frequently appearing patterns (namely knowledge), so that the language analyzing apparatus can more precisely classify the frequently appearing patterns so as to extract the knowledge.

Among the above-described conventional information mining techniques, more specifically, the mining works executed by the tools with employment of the mining techniques cannot be automatically carried out even in a near future, in which the texts written by human power are intended to be mined. That is, these mining works by the mining tools require high-level knowledge and human know-how in order to find out knowledge and to evaluate the mining results. Thus, while such mining works correspond to labor-intensive business by experts who own high-level knowledge, since a huge amount of expense is necessarily required in order that groups of such experts are grown up and maintained, such mining works with employment of the mining tools could not practically and easily conducted by firms at this stage. However, on the other hand, there is such a business environment that if firms cannot effectively utilize knowledge/know-how property stored in their firms, then these firms may not become winners in a global world-wide competition.

Since a specific attention is paid to the above-explained business environment, such information mining service providers have just appeared in the market. These service providers may be trusted by certain firms to accept information mining business from these firms and may provide information mining services to these firms. However, since the mining works are such works which necessarily depend upon individual man power, these mining works never consider cooperation works among plural analyzers and also higher efficiencies of analyzing operations.

### SUMMARY OF THE INVENTION

The present invention has been made to solve the above-described problems, and therefore, has an object to provide an information mining system capable of avoiding a repetitive searching operation, and of discovering various modes of knowledge in a higher efficiency in a mining work in which a plurality of analyzers who may provide mining services are operated in a cooperative manner.

An information mining system, according to an aspect of the present invention, is featured by that while a plurality of analyzers execute mining works at the same time in a parallel manner, operation history data of analyzing tools of mutual analyzers are sequentially compared with each other; and when such a judgement is made that a present operation history of one analyzer is resembled to such a history by which a consequence has already been acquired by another analyzer, such a warning that the former analyzer performs a repetitive analyzing operation is issued.

Other objects, features and advantages of the invention will become apparent from the following description of the embodiments of the invention taken in conjunction with the accompanying drawings.

### BRIEF DESCRIPTION OF THE DRAWINGS

FIG. 1 is a block diagram for schematically indicating an arrangement in which an information mining system, according to a first embodiment of the present invention, is mainly provided.

FIG. 2 is a sequential diagram for explaining a process operation of the information mining system according to the first embodiment.

FIG. 3 is an explanatory diagram for explanatorily displaying a screen of a relative word displaying tool used to display relative words in the information mining system of the first embodiment.

FIG. 4 is an explanatory diagram for explanatorily explaining a screen of an entire sentence retrieving tool used to retrieve a sentence containing a designated character string in the information mining system of the first embodiment.

FIG. 5 is an explanatory diagram for explanatorily displaying a screen of a resemblance sentence retrieving tool used to retrieve a sentence which is resembled to a designated sentence in the information mining system of the first embodiment.

FIG. 6 is an explanatory diagram for explaining a content of an under-analyzing operation history table used in the information mining system of FIG. 1.

FIG. 7 is an explanatory diagram for explaining a content of an operation history table used in the information mining system of FIG. 1.

FIG. 8 is an explanatory diagram for explaining a consequence history table used in the information mining system of FIG. 1.

FIG. 9 is a flow chart for describing a resemblance degree judging process operation as to an operation history in the information mining system of FIG. 1.

FIG. 10 is an explanatory diagram for explaining a screen displayed on a computer of an analyzer when warning is notified in the information mining system of FIG. 1.

FIG. 11 represents a sequential diagram as to a process operation in which an analyzed result is provided by a trustee to a requester in the information mining system of FIG. 1.

FIG. 12 is a block diagram for schematically showing an arrangement, in which an information mining system, according to a second embodiment of the present invention, is mainly employed.

FIG. 13 is a sequential diagram for indicating a process operation executed by the information mining system of FIG. 12.

FIG. 14 is a block diagram for schematically showing an arrangement, in which an information mining system, according to a third embodiment of the present invention, is mainly employed.

FIG. 15 is a sequential diagram for indicating a process operation executed by the information mining system of FIG. 14.

### DETAILED DESCRIPTION OF THE EMBODIMENTS

Referring now to drawing, various embodiments of the present invention will be described.

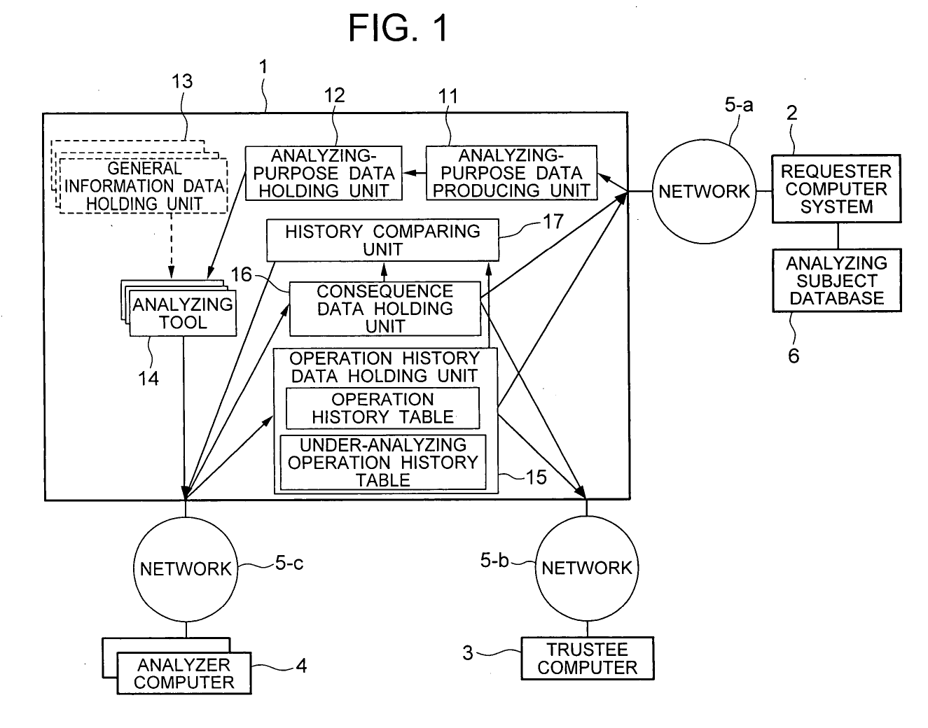

FIG. 1 is a schematic block diagram for indicating an arrangement in which an information mining system according to a first embodiment of the present invention is mainly arranged.

Reference numeral 1 shows an information mining system which is constituted by, for example, a computer such as a server. This information mining system 1 is connected via networks 5-1, 5-b, and 5-c such as the Internet to a computer system 2 of a requester, a computer system 3 of a trustee, and an analyzer computer 4. The computer system 2 of the requester requests an information mining service. The computer 3 of the trustee performs management of the information mining system. The analyzer computer 4 functions as a client who mines a database.

The computer system 2 of the requester is provided with an analyzing subject database 6 which has stored such an information as an electronic database, which is an information mining subject. This analyzing subject database 6 is constructed by way of a data warehouse technique, and the like, and this corresponds to, for instance, correspondence histories (generally, have been stored in form of free style sentences) with respect to customers in a call center; attribute data (generally, have been stored in form of coded numeral values) as to the customers; and data with respect to unquiet data and attributes of unquiet answering persons, business reports and attributes of staff members, and so on.

The information mining system 1 is equipped with an analyzing-purpose data producing unit 11, an analyzing-purpose data holding unit 12, a general information data holding unit 13, an analyzing tool 14, an operation history data holding unit 15, a consequence data holding unit 16, a history comparing unit 17, and the like.

The analyzing subject database 6 of the requester is transmitted via the network 5-a and the like to the analyzing-purpose data producing unit 11, and then, is converted by this analyzing-purpose data producing unit 11 into a format which may be processed by the information mining system 1. An analyzer operates the analyzing tool 14 by using the analyzer computer 4.

The analyzing tool 14 refers to the data held in the analyzing-purpose data holding unit 12 and the data held in the general information data holding unit 13, and holds a history of operations of the analyzer in the operation history data holding unit 15. An operation history under analyzing operation has been temporarily stored in an under-analyzing history table of the operation history data holding unit 15. Then, when a consequence is registered, the operation history is set in correspondence with the consequence, and is recorded in an operation history table of the operation history data holding unit 15. Also, the analyzing tool 14 holds such a consequence in the consequence data holding unit 16, which is equal to a result which has been registered by the analyzer. Contents of this operation history and this consequence are compared with each other by the history comparing unit 17, and then, the compared content is notified to the analyzer computer 4. Both the operation history data holding unit 15 and the consequence data holding unit 16 are constituted as such databases having logical structures in physical electronic data storage media such as memories and magnetic disks.

It should be noted that the general information data which has been stored in the general information data holding unit 13 corresponds to general-purpose social information (for example, time sequential information as to current events such as news, newspapers, and Web) which does not correspond to the information of the analyzing subject database 6. The format of this general information data has been converted into such a format which may be used by the analyzing tool 14. An analyzer may also find out a relationship between an analysis result and a social trend by comparing analyzing-purpose data with the general information data.

Next, a description is made of operations of the information mining system 1 according to the first embodiment of the present invention.

Conventionally, a trustee of a conventional mining service has referred to both a list of consequences and a list of knowledge obtained from a result of analysis from a list of consequences which have been registered by an analyzer. Also, there are many opportunities that analyzing operations by conventional mining services have been carried out by a single analyzer, and therefore, there is substantially no possibility that the same consequences appear in a list of consequences. That is because analysis needs using the conventional information mining system are limited.

However, very recently, since rapid analysis needs are highly increased among analysis needs, there is such a necessity that a plurality of analyzers must analyze the same analyzing subject data at the same time in a parallel manner. Especially, with respect to information mining services trusted by requesters, a major point of such information mining service business capable of gaining high evaluation and expensive fees from these requesters is how to find out highly valuable knowledge in higher efficiencies and various modes in view of temporal and costly aspects.

To this end, one method for executing a mining operation by a plurality of analyzers may be conceived. However, in such a case that a plurality of analyzers analyze analyzing subject data at the same time, there are some possibilities that one analyzer performs such an analyzing operation to conduct such a consequence which has already been reported by other analyzers. Such a fact that the same consequence could be obtained by the plural analyzers may increase reliability as to this consequence and a history, namely may increase value aspects as to this consequence and the history, but cannot suitably achieve such a purpose that various types of information are acquired within a predetermined time period.

To avoid this difficulty, another method may be conceived. That is, in such a case that a new consequence is reported by a certain analyzer, this new consequence is successively provided with respect to other analyzers. However, in accordance with this method, since a consequence which could be acquired by an analyzer is provided irrespective of a relationship with respect to an analysis result obtained under present analyzing operation, there is a risk that every time the above-described consequence is reported, other analyzers should interrupt their analyzing works so as to confirm the content of this provided consequence. Thus, in accordance with this method, there are many possibilities that analysis concentration of other analyzers is reduced, and as a result, efficiencies of the analyzing operations by other analyzers are lowered.

As a consequence, in accordance with the information mining system 1 of the first embodiment of the present invention, a consequence is provided with respect to other analyzers in the below-mentioned explanation.

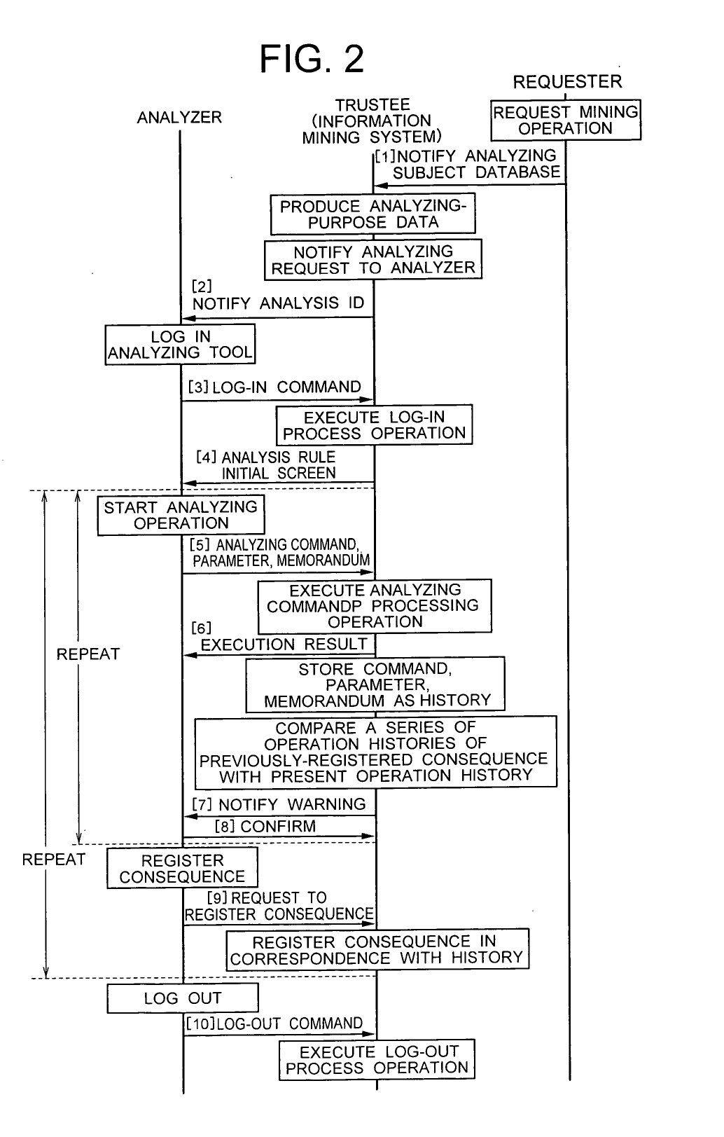

FIG. 2 is a sequential diagram for explaining process operations of the information mining system 1 of the first embodiment. This sequential diagram will now be described, while the process operations are subdivided into the below-mentioned 8 steps. It should be understood that a trustee corresponds to a manager of this information mining system 1, and both the trustee and the information mining system 1 are indicated by a single symbol in FIG. 2.

First, in a first step, a requester requests the trustee of the information mining system 1 to perform a data mining operation so as to trust the data mining operation.

Next, in a second step, the requester notifies information as to data stored in the analyzing subject database 6 with respect to the trustee, is connectable to the analyzing subject database 6 from the information mining system 1 (sequence 1), and transfers a data content of the analyzing subject database 6 via the network 5-a to the information mining system 1. Also, in the case that a transfer operation of data cannot be allowed, a connection to the analyzing subject database 6 from the information mining system 1 is established via the network 5-a under control of the requester, so that the requester can access the analyzing subject data. It should also be noted that analyzing subject data recorded on a recording medium may be sent/received from the requester to the trustee.

Next, in a third step, the analyzing subject data of the analyzing subject database 6 is converted into such a data format usable by the analyzing tool 14 by the analyzing-purpose data producing unit 11 of the information mining system 1, and analyzing-purpose data is produced, and then is held in the analyzing-purpose data holding unit 12.

Next, in a fourth step, the trustee notifies an analysis ID (namely, information related to access to analyzing tool 14, for instance, user ID for using analyzing tool 14) to a plurality of analyzers (analyzer computers 4), and requests a mining operation of the analyzing-purpose data to these plural analyzers (sequence 2). It should also be noted that a plurality of analyzers (analyzer computers 4) need not be always employed.

Next, in a fifth step, the analyzer who has received the mining request of the analyzing data inputs an analyzing ID as a log-in command with respect to the analyzing tool 14 by employing the analyzer computer 4, and thus, logs in the information mining system 1 (sequence 3). Since the analyzing ID is inputted, the analyzing tool 14 may be utilized, and then, an initial screen of the analyzing tool 14 is firstly displayed in the analyzer computer 4 (sequence 4).

Each of the analyzers browses (refers) the analyzing data, frames a certain hypothesis, and verifies the hypothesis by using the analyzing tool 14. This analyzing tool 14 corresponds to a set of analyzing tools used to perform analyzing operations from various angles, and is constituted by a plurality of tools.

When the analyzer executes the analyzing operation by using the analyzing tool 14, the analyzer may electronically write a memorandum in a memorandum column of the analyzing tool 14 and may record this memorandum. This memorandum is sequentially recorded in the operation history data holding unit 15 of the information mining system 1 in combination with a history of process operations executed by the analyzing tool 14. Furthermore, a result of the verification of the hypothesis and a comment may be written into the memorandum column so as to be recorded. For instance, in the case that the verification of the hypothesis succeeds and certain useful knowledge is obtained, this useful knowledge is registered. In the case that the verification of the hypothesis fails, this failure is registered. When the analyzer gives up the execution of the verification, this fact is registered (sequences 5, 6 and 9).

While an analyzer performs an analyzing work, a history of operation which the analyzer has performed with respect to the analyzing tool 14 is sequentially recorded on the operation history data holding unit 15 of the information mining system 1 with respect to each of the analyzers every time the analyzing process operation is carried out. Also, in such a case that an analyzer instructs to register as a consequence such a memorandum into which a result of verification of a hypothesis has been written, this memorandum becomes a “consequence.” The information mining system 1 records a content of a consequence in the consequence data holding unit 16 in correspondence with an operation history of a series of verification by which this consequence could be obtained.

It should be understood that until the registering operation of the consequence is carried out, the operation history obtained under analyzing operation is temporarily stored in the under-analyzing operation history table of the operation history data holding unit 15. Then, when the consequence is registered, the operation history is recorded in the operation history table of the operation history data holding unit 15 in correspondence with the consequence. When the consequence is recorded in the operation history table, the operation history corresponding to this consequence is deleted from the under-analyzing operation history table. In other words, the operation history is moved.

Next, in a sixth step, every time the analyzer under analyzing operation executes an analyzing operation, namely every time an operation history is added, the information mining system 1 is operated in such a manner that the history comparing unit 17 compares the operation history related to the present analysis by the analyzer with the past operation history recorded in the operation history table. In such a case that the history comparing unit 17 judges that there is a high resemblance degree between the operation history of the analyzer under analyzing operation and an operation history (otherwise, a portion of this operation history) corresponding to such a consequence which has been registered by another analyzer (otherwise, analysis performed by own analyzer in past), the history comparing unit 17 notifies warning with respect to the analyzing tool 14 (analyzer computer 4 of analyzer himself), and further, displays a list of consequences and memorandums, which correspond to the operation history whose resemblance degree is high (sequence 7). An analyzer who has received this warning executes a confirmation operation with respect to the warning (sequence 8).

When the analyzer confirms the list, and then, the consequence with respect to the hypothesis framed by the own analyzer has already been acquired by another analyzer (otherwise, analysis result which was obtained in past by himself), this analyzer may interrupt the mining work in order to avoid the repetitive search.

Also, even in such a case that a consequence has already been acquired, an analyzer may continue to execute a work. This is because there is the below-mentioned possibility. That is, even if the operation histories up to such a time instant when the operation histories are shown are resembled to each other, there is such a possibility that another consequence may be obtained in a succeeding analyzing operation., which is different from the previous consequence, and/or this analyzer may find out an event which may conduct that new knowledge is found out. In this case, assuming now that the same consequences are finally obtained, although values thereof are low in view of a variety of information mining operations, the same consequences may constitute such information capable of reinforcing a certainty of the consequences. A judgement of a resemblance degree by this history comparing unit 17 may be carried out by expressing a resemblance characteristic of an analysis subject, a resemblance characteristic of an analysis condition (retrieve keyword and numeral value), and resemblance characteristic of operations and operation flows by numeral values.

The above-described fifth step and sixth step are repeatedly carried out. Then, in a seventh step, in such a case that a predetermined constant time period (for example, delivery deadline designated by requester) has elapsed, or a preselected number of consequences (for example, results obtained based upon cost designated by requester) can be obtained, the analyzer accomplishes the analyzing operation, and performs a log-out process operation from the analyzing tool 14. When the analyzer executes the log-out process operation, or a notification as to the completion of the analyzing operation is issued from this analyzer, a series of the analyzing process operation is ended (sequence 10).

Then, the trustee acquires the lists of the consequences in which the analysis results of the analyzer are reported from the consequence data holding unit 16. The trustee collects the lists of these consequences together. This collecting operation is carried out in such a way that, for example, such consequences, the transcription and expressions of which are different from each other, but which indicate the same contents, are collected so as to obtain one consequence. Otherwise, an evaluation operation is carried out by considering the contents of the acquired consequences.

Next, an outline of the analyzing tool 14 which is manipulated by an analyzer will now be explained. The analyzing tool 14 of the first embodiment corresponds to a set of software for analyzing information from various angles, and is constituted by a plurality of tools. It should also be understood that in an embodiment of the present invention, such an example is shown in which a text mining tool for analyzing text information within the above-described information has been employed. Alternatively, a data mining tool such as an OLAP tool may be utilized as one of the analyzing tools.

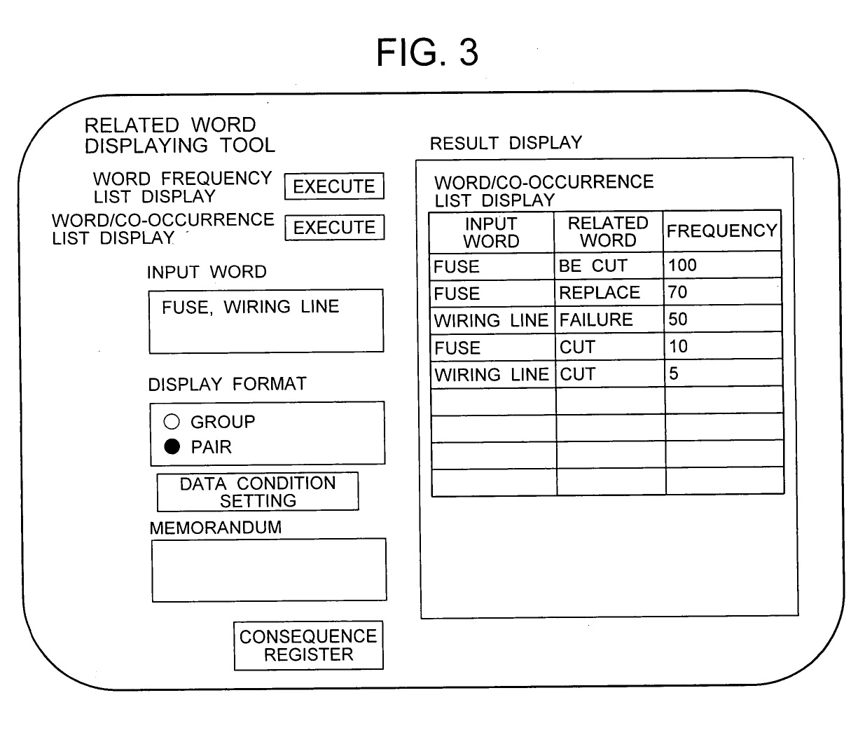

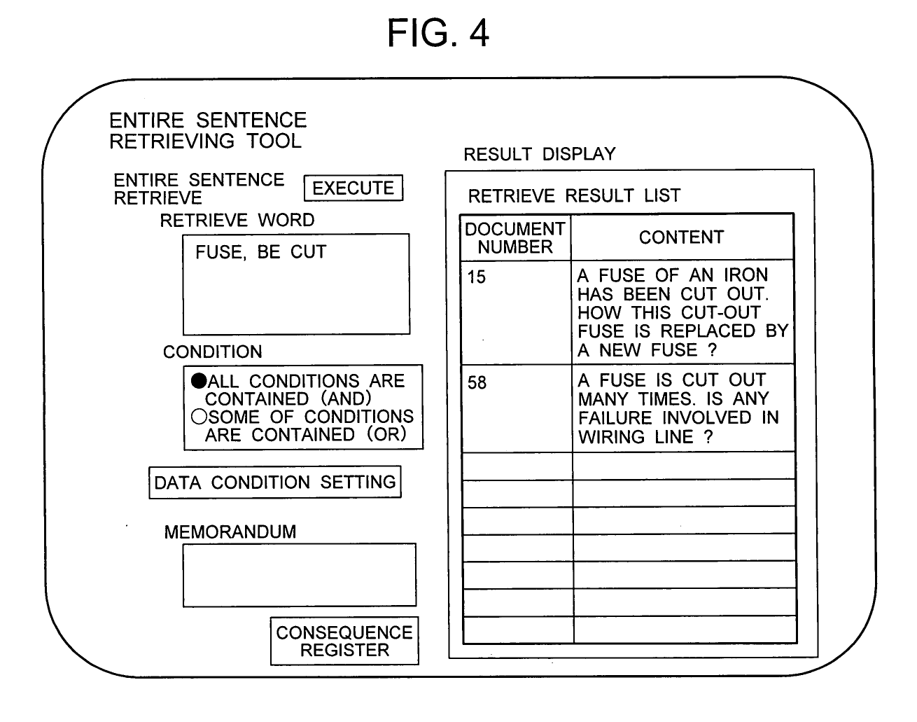

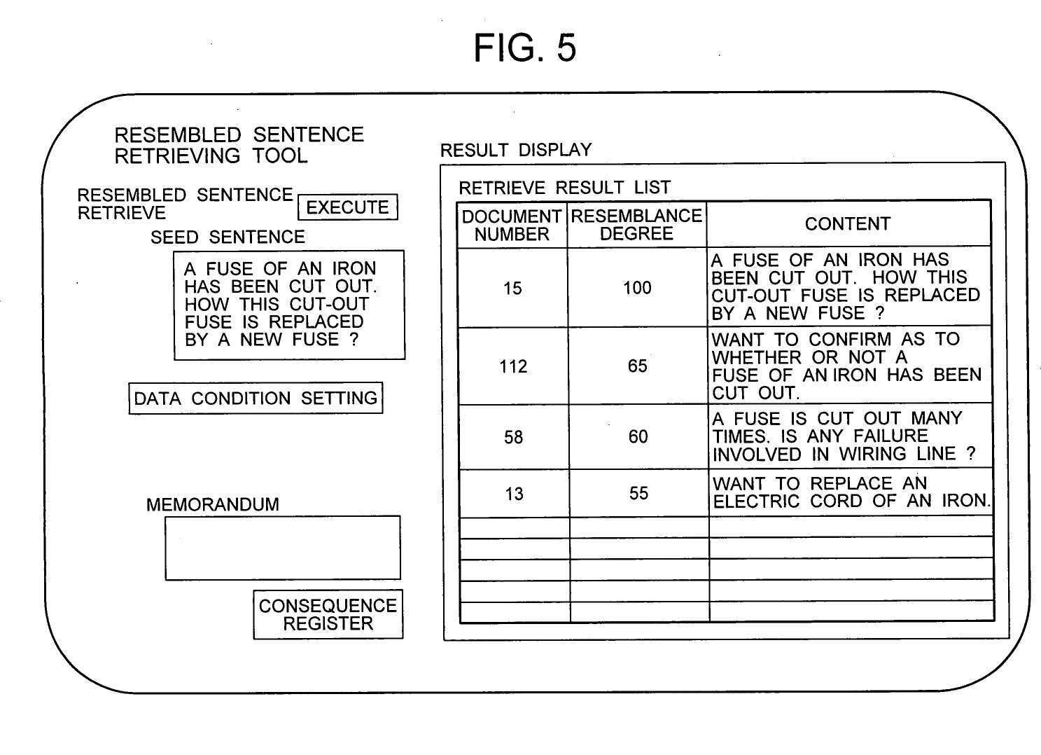

FIG. 3, FIG. 4, and FIG. 5 represent an example of an analyzing tool for mining information from a text, according to the first embodiment.

FIG. 3 is an example of a screen display as to a related word displaying tool for displaying a related word. This related word displaying tool can provide such a co-occurrence relationship, namely, which words are expressed in a sentence contained in analyzing subject data. Otherwise, while one, or more pieces of these words are designated, what sorts of same documents are present, what sorts of same sentences are present, or which adjoining words appear. Also, how degree the same documents, the same sentences, or the adjoining words appear. The example of FIG. 3 indicates a retrieve result obtained by that what sort of related words are expressed in a sentence which contains such words as “fuse” and “wiring line.” That is, retrieve results of “be cut”, “replace”, “failure”, and “cut out” are shown.

FIG. 4 is an example of a screen display of an entire sentence retrieving tool which retrieves a sentence containing a designated character string. The entire sentence retrieving tool can refer to, for instance, a list of documents which contain related words obtained by the related word displaying tool, and can directly confirm that the related words are used in what context. In the example shown in FIG. 4, such a result is shown which has retrieved a sentence containing such words as “fuse” and “be cut.”

FIG. 5 is an example of a screen display of a resemblance sentence retrieving tool for retrieving a sentence which is resembled to a designated sentence. The resemblance sentence retrieving tool can acquire, for example, a list of sentences which are resembled to one designated sentence from a document obtained by an entire sentence retrieving tool. For instance, the resemblance sentence retrieving tool owns such a function that differences contained in transcription such as “PC” and “personal computer” are absorbed by employing a synonym dictionary, and while a featured word contained in a designated sentence is extracted, documents having similar featured words to the extracted featured word are provided in a top priority. This resemblance sentence retrieving tool corresponds to an effective analyzing tool when documents whose contents are resembled to each other are wanted to be displayed although these documents are not involved in the list in the entire sentence retrieving operation. In the example shown in FIG. 5, such a retrieve result is provided by retrieving synonym sentences having implication similar to such a sentence that “when a fuse of an iron is cut out, how to replace this melted fuse by new fuse.”

It should also be noted that these analyzing tools are equipped with memorandum input columns and consequence registering buttons. The memorandum input columns are such regions into which comments and consequences are entered. The consequence registering buttons correspond to such buttons that when a certain consequence is obtained from a series of analyzing operation, an analyzer instructs a process operation for registering a comment as a consequence, which is entered by the analyzer as a memorandum.

Next, a description is made of both the under-analyzing operation history table and the operation history table, which are contained in the history data holding unit 15 of the information mining system 1 according to the first embodiment.

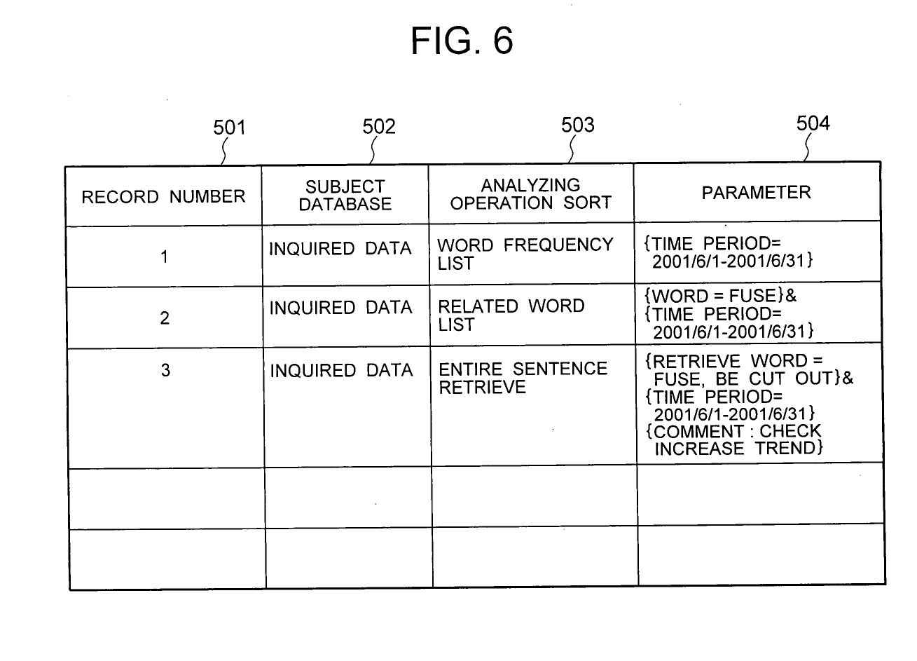

FIG. 6 indicates an example of the under-analyzing operation history table. The under-analyzing operation history table owns such fields as a record number 501, subject database identification information 502, an analyzing operation sort 503, and a parameter 504. The record number 501 holds a time sequential order of recorded contents. The subject database identification information 502 indicates a content of data which is to be analyzed, and is held in the analyzing-purpose data holding unit 12. The analyzing operation sort 503 indicates a sort of a used analyzing tool. The parameter 504 has been transmitted with respect to an analyzing tool indicative of a content of a process operation which has been executed in the analyzing tool in this operation. The under-analyzing operation history tables are independently prepared every analyzer (or in unit of log-in), and operation histories obtained under analyzing operation are temporarily stored in these under-analyzing operation tables.

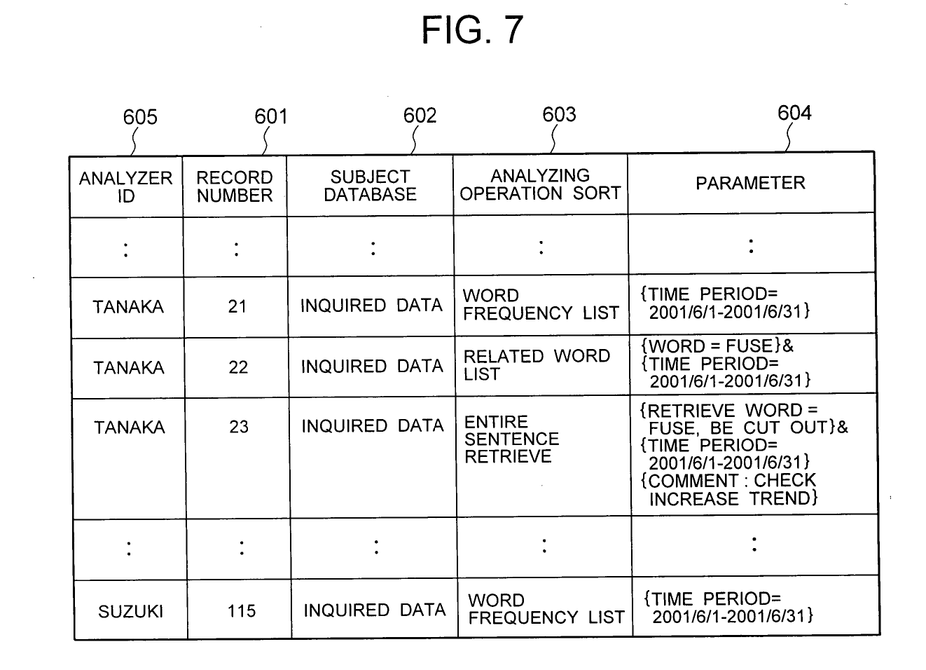

FIG. 7 indicates an example of the operation history table. The operation history table owns such fields as a record number 601, subject database identification information 602, an analyzing operation sort 603, a parameter 604, and analyzer identification information (analyzer ID) 605. The record number 601 holds a time sequential order of recorded contents. The subject database identification information 602 indicates a content of data which is to be analyzed, and is held in the analyzing-purpose data holding unit 12. The analyzing operation sort 603 indicates a sort of a used analyzing tool. The parameter 604 has been transmitted with respect to an analyzing tool indicative of a content of a process operation which has been executed in the analyzing tool in this operation. The analyzer identification information (analyzer ID) 605 indicates that the relevant operation has been carried out by which analyzer.

When the record number 501 of the under-analysis operation history table is moved to the operation history table, numbers are reallocated by the operation mining system 1 in such a manner that this record number 501 may have an exclusively-selected value based upon the record number 601 of the operation history table, while the time sequence is maintained in the unit of consequence. Also, into the parameters 503 and 603 of the under-analyzing operation history table and the operation history table, memorandums which have been formed at arbitrary intermediate stages of analyzing operations by an analyzer may be stored as comments. It should also be understood that consequences and comments are not limited only to texts, but may be made by voice, images, moving pictures etc. If any items can be understood by any persons who refer to these items, then there is no question as to data formats. However, in this embodiment, a description is made of such an initial condition that consequences and comments are recorded in text formats.

Next, a description is made of a consequence table which is held in the consequence data holding unit 16 of the information mining system 1.

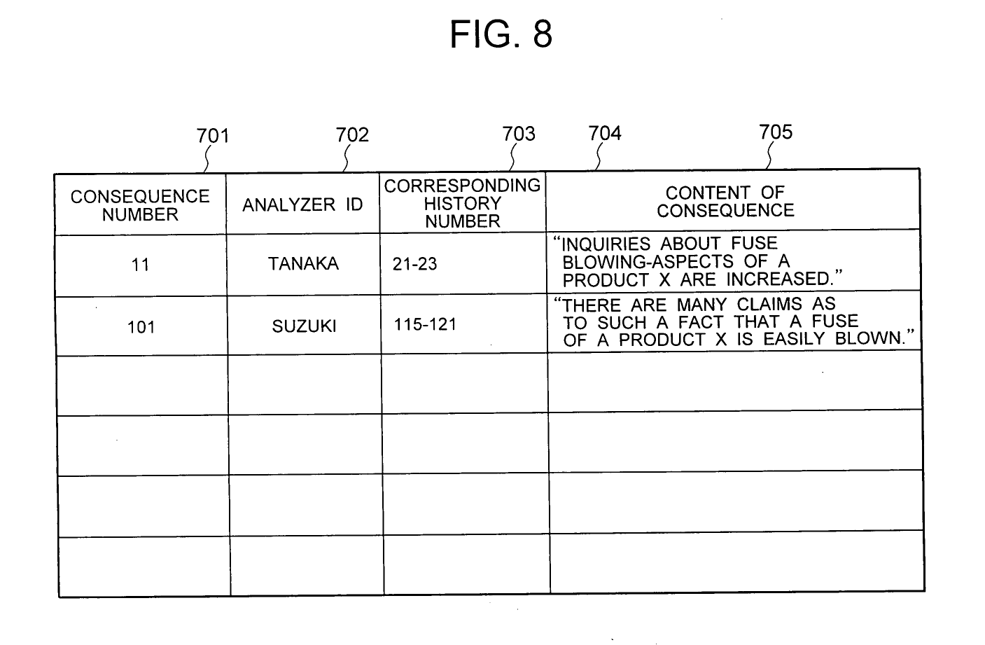

FIG. 8 shows an example of the consequence table. The consequence table is constituted by the respective fields, namely, a consequence number 701, analyzer identification information (analyzer ID) 702, a corresponding history number 703, and a consequence content 704. The consequence number 701 corresponds to an identifier which exclusively identifies a consequence. The analyzer identification information 702 indicates such an analyzer who has registered the relevant consequence. The corresponding history number 703 represents an operation history corresponding to the relevant consequence within the range of the record number 601 of the above-described operation history table. The consequence content 704 shows a memorandum which is inputted as a content of a consequence.

Next, a description is made of a judging process operation of a resemblance degree executed in the history comparing unit 17.

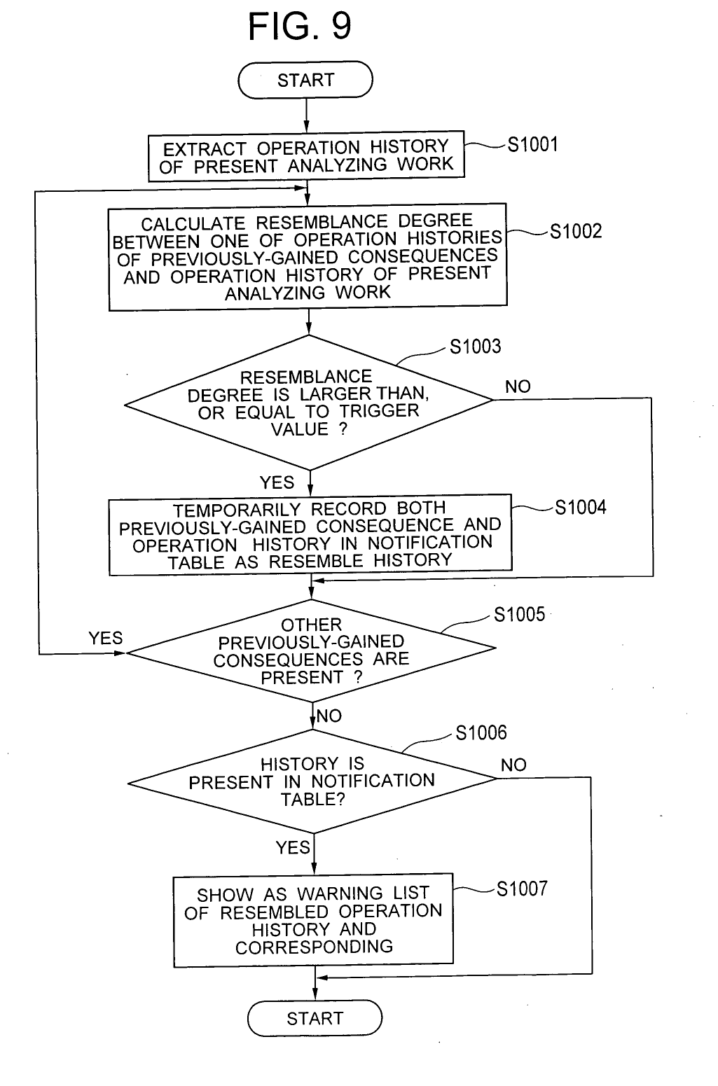

FIG. 9 is a flow chart for describing a process operation for judging a resemblance degree of an operation history executed in the history comparing unit 17.

When an analyzer executes an operation of the analyzing tool 14 in this flow chart, the history comparing unit 17 firstly acquires an operation history of an analyzing work which is presently carried out by this analyzer from the under-analyzing operation history table (step S1001).

Next, the history comparing unit 17 refers to both the consequence table and the operation history table, acquires a group of operation histories which have been defined in correspondence with the corresponding history numbers of the consequence table, and then compares one of the previously-acquired operation histories of the consequence with the operation history acquired from the under-analyzing operation history table so as to calculate a resemblance degree of the operation history of the presently-executed analyzing work (step S1002).

To calculate the resemblance degree in this step S1002, various calculation methods have been proposed. For example, in such a case that contents of databases as to a preset number of operations which have been defined in a time sequential manner in analyzing operations from the beginning stages, operation sorts, parameters with respect to these operation histories are completely made coincident with each other, a resemblance degree of the presently-executed operation history is 100%. Also, in the case that only parameters are different from each other, this difference may be evaluated as a resemblance degree. As to this preset number of operations, an initial value is set in such a manner that the resemblance degree is judged after the operations executed by the analyzer have been stored to some extent. The reason why such an initial value is set is given as follows: That is, since the most analyzing processes are resembled to each other at an initial stage of the operations, such a judgement can be avoided that substantially all operations are resembled to each other.

Concretely speaking, in the resemblance sentence retrieving tool, sentences of parameters are analyzed as to form elements thereof. As a result, the same form elements are arrayed, and a ratio of a total number of these same form elements with respect to the entire form element may be employed as a resemblance degree. Also, as described in the patent publication 2 corresponding to the prior art, form elements are cut out from a sentence, a cross-relationship (for example, cross-relationship between words, e.g., “fuse”→“be cut out”) is extracted, and a ratio of a total number of coincident words with respect to a total character number of both the sentences is normalized, and then, the normalized number may be used as a resemblance degree. Further, in the entire sentence retrieving operation, retrieve character strings of parameters are compared with each other by employing the DP matching method, namely, differences in synonym words such as “PC” and “personal computer” are compared with each other, so that the comparison result may be set as a resemblance degree. In addition, in the data mining operation, a relative coefficiency between data of parameters, or the like may be employed as a resemblance degree. Resemblance degrees which have been calculated every time operation histories are compared with each other are normalized based upon a total number of compared operations, and then, the normalized value is compared with a trigger value.

Then, the history comparing unit 17 compares and judges this resemblance degree with a predetermined threshold value (trigger value) (step S1003). As a result of the comparison/judgement, in such a case that the history comparing unit 17 judges that the resemblance degree is larger than, or equal to the trigger value, since the resemblance degree is high, the process operation is advanced to a step S1004. In this step S1004, this consequence is recorded in a notification table corresponding to a temporary buffer. When the history comparing unit 17 judges that the resemblance degree is smaller than the trigger value, since the operation histories are not resembled to each other, the process operation is advanced to a step S1005, while this consequence is not recorded in the notification table (step S1004).

In the step S1005, the history comparing unit 17 judges as to whether or not there is another content (consequence data) of such a consequence table whose resemblance degree has not yet been judged. If there is consequence data whose resemblance degree has not yet been judged, then the process operation is returned to the step 1002. In this step S1002, the history comparing unit 17 repeatedly carries out a judging operation as to a resemblance degree plural times which are equal to a total number of consequences registered in the consequence table.

Next, the history comparing unit 17 judges as to whether or not consequence data is recorded in the above-explained notification table (step S1006). In such a case that the consequence data is recorded in the notification table, the process operation is advanced to a step S1007. In this step S1007, the history comparing unit 17 notifies such a warning that the consequences are resembled to each other with respect to the analyzer, and further, notifies a list of the consequence data which have been judged to be resembled thereto with respect to the analyzer computer 4. On the other hand, in such a case that the consequence data is not recorded in the notification table, since the previously-registered consequence data does not contain such an operation content of the analyzer which is resembled to the above-described consequence data, the process operation is directly ended. While the history comparing unit 17 does not notify such a warning that the consequences are resembled to each other with respect to the analyzer (step S1007).

Next, a notification of warning executed in the above-described step 1007 of FIG. 9 will now be explained.

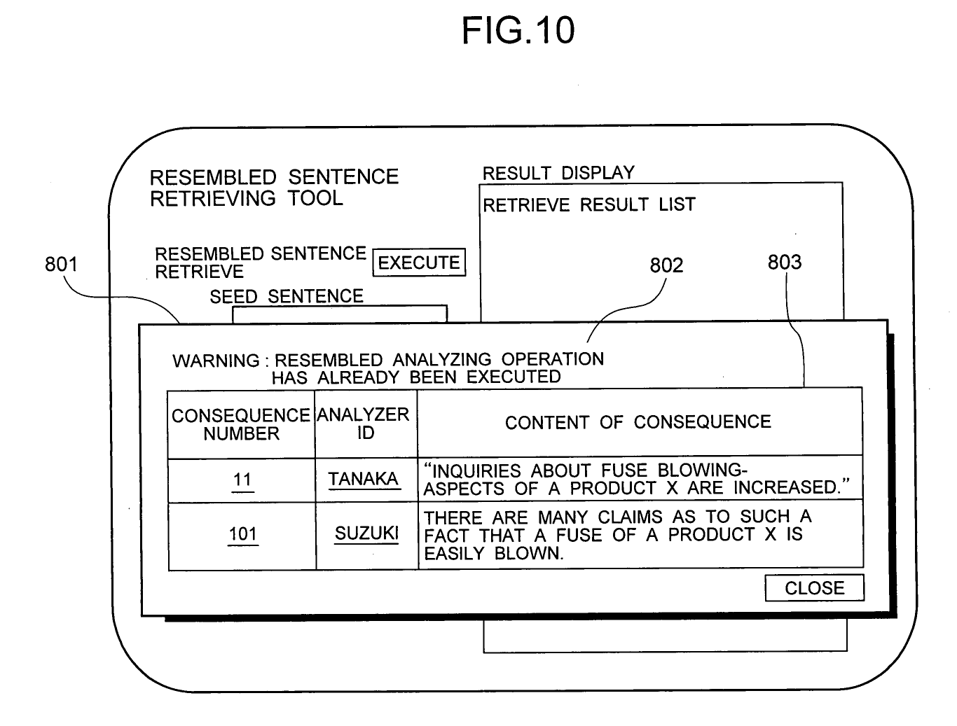

FIG. 10 is an example of a screen displayed on the analyzer computer 4 when warning is notified.

The warning is notified by executing the analyzing tool 14 to the analyzer computer 4 based upon a judgement result of a resemblance degree by the history comparing unit 17, which is carried out when the operation of the analyzing tool 14 is carried out. In other words, a display of the warning (displayed on analyzer computer 4) which is notified with respect to the analyzing tool 14 based upon the result of the history comparing unit 17 constitutes a warning notifying unit.

On a warning window 801 for representing this warning to the analyzer, both a warning message 802 indicative of a content of the warning and a consequence list 803 are displayed. The consequence list 803 indicates contents of consequences of resembled operation histories. This consequence list 803 contains consequence numbers, identification information (analyzer IDs) of analyzers who have registered consequences, and consequence contents.

It should be noted that the following function may be alternatively added to the analyzing tool 14. In accordance with this function, while a consequence number is employed as an anchor, when an analyzer designates the consequence number, an operation history corresponding to this designated consequence number is displayed. Also, while an analyzer ID is used as an anchor, when an analyzer designates the analyzer ID, a consequence list of this analyzer is displayed. Also, independent from the screen of the warning, such a function for displaying a consequence list at an arbitrary time instant and for referring to this consequence list may be added to the analyzing tool. Such an additional function may be readily realized by using the known technique such as a Web application.

Next, as an eighth step, a description is made of a service which is performed by a trustee based upon a consequence conducted by an analyzer.

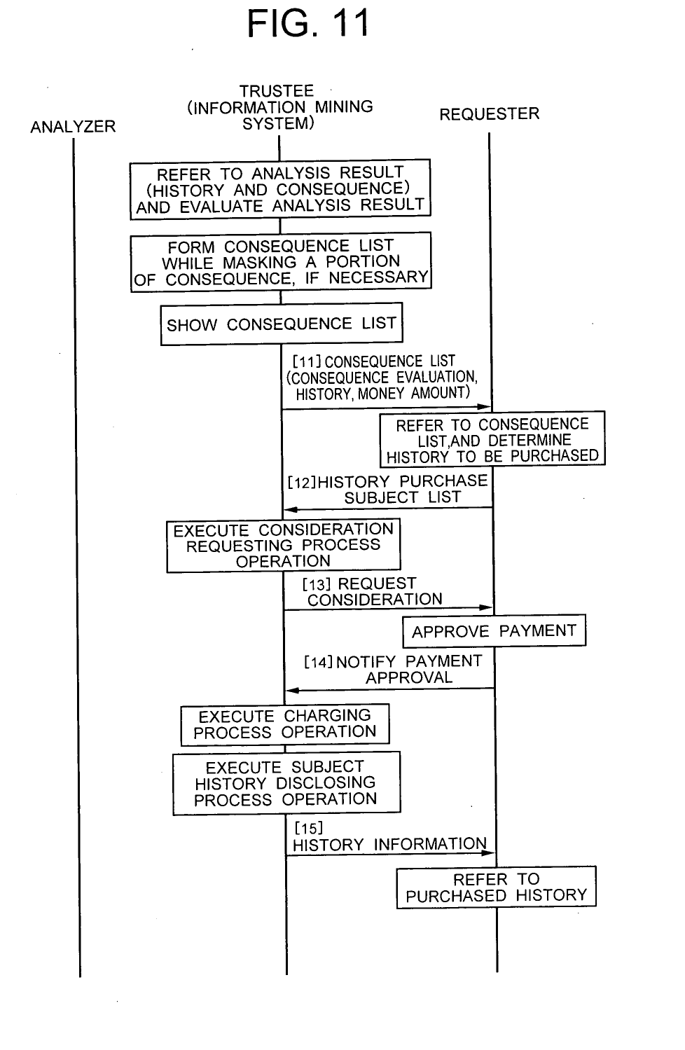

FIG. 11 is a sequential diagram for explaining a process operation by which an analyzed result is provided by a trustee with respect to a requester.

As previously explained, the trustee collects the results (both consequences and histories for obtaining consequence) which have been analyzed by the analyzer, and executes evaluating operation with respect to the respective consequences.

Then, the trustee performs such a service that operation history data which has been acquired during the analyzing operation is provided to the request in response to the request issued from the requester. Consequence data owns such a value as formalized knowledge, whereas history data may be grasped in such a way that a portion of tacit knowledge such as a know-how capable of obtaining this knowledge is represented, and the history data may be conceived by that a value which is not deteriorated, as compared with a consequence is present.

The trustee shows a list of the evaluated consequences to the requester. In this case, the trustee contains only the consequences with respect to the mining request of the analyzer in the list, and in such a case that the trustee has conducted such consequences which does not constitute the results for the mining request, but are seemed to be useful, the trustee may alternatively represent the conducted consequences to the request by separately receiving a consideration.

Next, the trustee shows the collected consequences, the evaluation for the consequences, and an amount of money when a history corresponding to the consequences is purchased, respectively (sequence 11).

When the requester determines to purchase such a history for the consequences, which has been judged to be required by referring to the consequences by this requester, the requester collects this history as a history purchase subject list, and then, issues a purchase request (sequence 12).

When the trustee accepts the purchase request of the history, this trustee calculates a money amount as to purchase considerations of the histories, and shows the calculated money amount to the requester, and also demands payment of this requester (sequence 13). When the requester accepts this payment demand, this requester receives an approval of payment for the consideration, and then, sends a payment approval notification for this consideration (sequence 14).

Upon receipt of the payment approval notification, the trustee performs a charging process operation, and then, performs an opening process operation as to subject history data (sequence 15). Since the requester receives a result of this opening process operation, the requester can refer to the purchased history.

If the utilization of the analyzing tool 14 is defined as a service menu, then the requester may confirm the justified route thereof by tracing (reproducing) a verification route by employing operation history data, and further, the requester may provide a new service capable of mastering analysis know-how.

It should also be noted that the evaluation of the consequence which is executed when the above-described trustee collects the consequences may be automatically carried out by employing the above-explained resemblance degree judgement defined in the step S1002 of FIG. 9.

The evaluation of the consequences is classified into four sorts of evaluation as follows:

(a). The consequences are resembled to each other, and the operation histories are resembled to each other (there is very high possibility that same analysis contents are obtained).

(b). Although the consequences are not resembled to each other, the operation histories are resembled to each other (there is high possibility that although same analysis contents are obtained, expressions of consequences are different from each other).

(c). Although the consequences are resembled to each other, the operation histories are not resembled to each other (there is high possibility that same consequences are supported by different analyzing steps).

(d). Neither the consequences are resembled to each other, nor the operation histories are resembled to each other (analysis contents of consequences are different from each other).

Normally, the trustee classifies evaluation of consequences into the above-described four sorts of evaluation with reference to contents of these consequences. Alternatively, the history comparing unit 17 may perform a resemblance degree judgement so as to automatically classify evaluation of consequences.

In general, consequences of an analyzer are described by using a natural language in order that a requester can understand these consequences. In the case that a trustee tries to evaluate these consequences, this trustee is required to give the same evaluation with respect to the same analysis contents. However, while a natural language contains a fluctuation of expression, if evaluation of a consequence is classified based upon only information of the consequence, then precision of this classification is deteriorated. Accordingly, a comparison result of a consequence is combined with a comparison result of operation history in the above-described manner, and the consequence is classified, so that an evaluation work can be carried out in a higher efficiency.

As previously explained, in the information mining system according to the first embodiment, a series of analyzing operations while a plurality of analyzers perform the analyzing operations are recorded in the under-analyzing operation history table, and this recorded operation is sequentially compared with both the previously-registered consequence and the operation history table in which a series of analyzing operations corresponding to this consequence have been stored in correspondence therewith so as to judge the resemblance degree. Then, since the information mining system issues the warning to the operator based upon the comparison result made by the judged resemblance degree and the predetermined threshold value (trigger value), the repetitive analyzing operations can be avoided while the plural analyzers perform the mining operations at the same time in the parallel manner.

Next, an information mining system 1 according to a second embodiment of the present invention will now be described with reference to drawings.

The information mining system 1 of the second embodiment owns the following different points, as compared with that of the first embodiment. That is, analyzing tools 14-a and 14-b are provided in an analyzer computer 4 provided on the side of an analyzer. Analyzing-purpose data, data as to an operation history and a consequence, and information are transmitted/received via a network 5-c with respect to the information mining system 1. It should be noted that the same reference numerals shown in the first embodiment will be employed as those for denoting the structures operable in the same operation manners in the second embodiment, and explanations thereof are omitted.

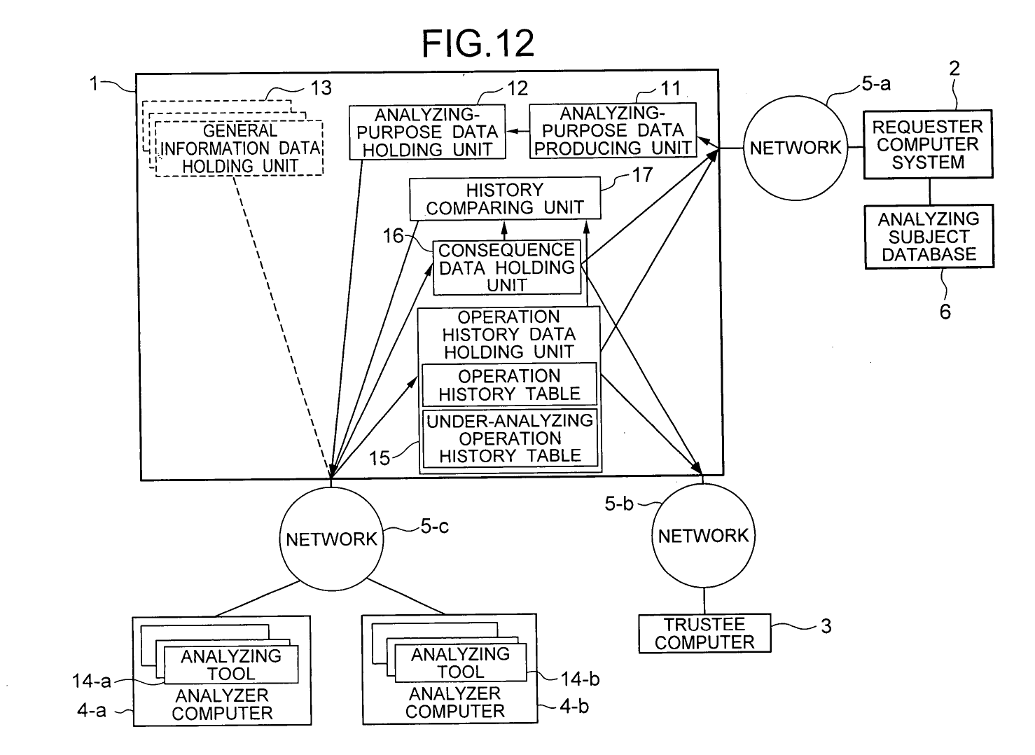

FIG. 12 is a schematic block diagram for indicating an arrangement in which the information mining system 1 of the second embodiment is mainly arranged.

The information mining system 1 is not equipped with an analyzing tool, whereas the analyzing tool 14-a and the analyzing tool 14-b are provided in a computer 4-a and another computer 4-b of the analyzers, respectively.

It should also be noted that this analyzing tool 14 may be alternatively employed in the analyzer computer 4 from the beginning stage. Alternatively, this analyzing tool 14 may be stored in a storage unit of the information mining system 1, and then, this stored analyzing tool 14 may be downloaded to the analyzer computer 4 when an analysis ID is notified.

Next, operations of the information mining system 1 of the second embodiment will now be described, while the operations are subdivided into 8 steps as previously explained in FIG. 2.

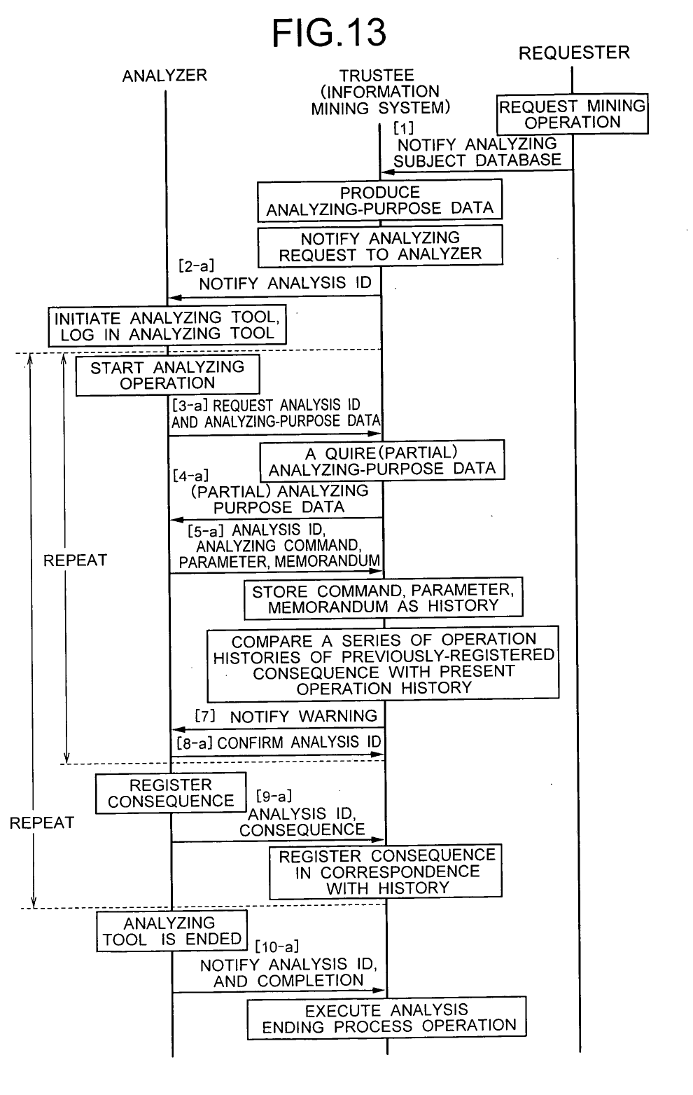

FIG. 13 is a sequential diagram for indicating process operations of the information mining system 1 according to the second embodiment.

It should be understood that similar to the explained structure in FIG. 2, a trustee corresponds to a manager of this information mining system 1, and both the trustee and the information mining system 1 are indicated by a single symbol.

First, in a first step, a requester requests the trustee of the information mining system 1 to perform a data mining operation so as to trust the data mining operation.

Next, in a second step, the requester notifies information as to data stored in the analyzing subject database 6 with respect to the trustee, is connectable to the analyzing subject database 6 from the information mining system 1 (sequence 1), and transfers a data content of the analyzing subject database 6 via the network 5-a to the information mining system 1. Also, in the case that a transfer operation of data cannot be allowed, a connection to the analyzing subject database 6 from the information mining system 1 is established via the network 5-a under control of the requester, so that the requester can access the analyzing subject data. It should also be noted that analyzing subject data recorded on a recording medium may be sent/received from the requester to the trustee.

Next, in a third step, the analyzing subject data of the analyzing subject database 6 is converted into such a data format usable by the analyzing tool 14 by the analyzing-purpose data producing unit 11 of the information mining system 1, and analyzing-purpose data is produced, and then is held in the analyzing-purpose data holding unit 12.

Next, in a fourth step, the trustee notifies an analysis ID (namely, information related to access to analyzing tool 14, for instance, user ID for using analyzing tool 14) to a plurality of analyzers (analyzer computers 4), and requests a mining operation of the analyzing-purpose data to these plural analyzers (sequence 2-a). It should also be noted that a plurality of analyzers (analyzer computers 4) need not be always employed.

Next, in a fifth step, the analyzer who has received the mining request of the analyzing data initiates the analyzing tool 14 in the analyzer computer 4, and inputs the analysis ID as a log-in command with respect to the analyzing tool 14, and thus, logs in the analyzing tool 14. Since the analysis ID is inputted, the analyzing tool 14 can be used, so that the analyzer can commence to analyze the data. In this case, in accordance with an analyzing operation, the analyzing tool 14 requests the analyzing-purpose data which has been stored in the information mining system 1 via the network 5-c (sequence 3-a).

The information mining system 1 transmits the analyzing-purpose data which has been received the request from the analyzing-purpose data holding unit 12 with respect to the computer analyzing tool 14 of the analyzer (sequence 4-a). It should be understood that when the analyzing tool 14 sends such information as data, a memorandum, and a consequence with respect to the information mining system 1, this analyzing tool 14 transmits this information in combination with the analysis ID notified in Step 4. The information mining system 1 can recognize that such an operation is performed from which analyzer based upon this analyzing ID.

Each of the analyzers browses (refers) the analyzing data, frames a certain hypothesis, and verifies the hypothesis by using the analyzing tool 14. In this case, the analyzer may electronically write a memorandum in a memorandum column of the analyzing tool 14 and may record this memorandum. This memorandum is sequentially recorded via the network 5-c in the operation history data holding unit 15 of the information mining system 1 in combination with a history of process operations executed by the analyzing tool 14. Furthermore, a result of the verification of the hypothesis may be written as a consequence and a comment into the memorandum column so as to be recorded. For instance, in the case that the verification of the hypothesis succeeds and certain useful knowledge is obtained, this useful knowledge is registered. In the case that the verification of the hypothesis fails, this failure is registered. When the analyzer gives up the execution of the verification, this fact is registered (sequences 5-a and 9-a).

While an analyzer performs an analyzing work, a history of operation which the analyzer has performed with respect to the analyzing tool 14 is sequentially recorded via the network 5-c on the operation history data holding unit 15 of the information mining system 1 with respect to each of the analyzers every time the analyzing process operation is carried out. Also, in such a case that an analyzer instructs to register as a consequence such a memorandum into which a result of verification of a hypothesis has been written, this memorandum becomes a “consequence.” The analyzing tool 14 records a content of a consequence in the consequence data holding unit 16 of the information mining system 1 in correspondence with an operation history of a series of verification by which this consequence could be obtained.

It should be understood that until the registering operation of the consequence is carried out, the operation history obtained under analyzing operation is temporarily stored in the under-analyzing operation history table of the operation history data holding unit 15. Then, when the consequence is registered, the operation history is recorded in the operation history table of the operation history data holding unit 15 in correspondence with the consequence. When the consequence is recorded in the operation history table, the operation history corresponding to this consequence is deleted from the under-analyzing operation history table. In other words, the operation history is moved.

Next, in a sixth step, every time an operation history is added which has been performed by the analyzer under analyzing operation and is transmitted via the network 5-c, the information mining system 1 is operated in such a manner that the history comparing unit 17 compares the operation history related to the present analysis by the analyzer with the past operation history recorded in the operation history table. In such a case that the history comparing unit 17 judges that there is a high resemblance degree between the operation history of the analyzer under analyzing operation and an operation history (otherwise, a portion of this operation history) corresponding to such a consequence which has been registered by another analyzer (otherwise, analysis performed by own analyzer in past), the history comparing unit 17 notifies warning via the network 5-c with respect to the analyzing tool 14 (analyzer computer 4 of analyzer himself), and further, displays a list of consequences and memorandums, which correspond to the operation history whose resemblance degree is high (sequence 7). An analyzer who has received this warning executes a confirmation operation with respect to the warning (sequence 8-a).

When the analyzer confirms the list, and then, the consequence with respect to the hypothesis framed by the own analyzer has already been acquired by another analyzer (otherwise, analysis result which was obtained in past by himself), this analyzer may interrupt the mining work in order to avoid the repetitive search.

Also, even in such a case that a consequence has already been acquired, an analyzer may continue to execute a work. This is because there is the below-mentioned possibility. That is, even if the operation histories up to such a time instant when the operation histories are shown are resembled to each other, there is such a possibility that another consequence may be obtained in a succeeding analyzing operation, which is different from the previous consequence, and/or this analyzer may find out an event which may conduct that new knowledge is found out. In this case, assuming now that the same consequences are finally obtained, although values thereof are low in view of a variety of information mining operations, the same consequences may constitute such information capable of reinforcing a certainty of the consequences. A judgement of a resemblance degree by this history comparing unit 17 may be carried out by expressing a resemblance characteristic of an analysis subject, a resemblance characteristic of an analysis condition (retrieve keyword and numeral value), and resemblance characteristic of operations and operation flows by numeral values.

The above-described fifth step and sixth step are repeatedly carried out. Then, in a seventh step, in such a case that a predetermined constant time period (for example, delivery deadline designated by requester) has elapsed, or a preselected number of consequences (for example, results obtained based upon cost designated by requester) can be obtained, the analyzer accomplishes the analyzing operation, and performs a log-out process operation from the analyzing tool 14. Either this log-out process operation by the analyzer or the notification of the completion issued from the analyzer is transferred from the analyzing tool 14 via the network 5-c to the information mining system 1, so that a series of the analyzing process operations is ended (sequence 10-a).

Then, the trustee acquires the lists of the consequences in which the analysis results of the analyzer are reported from the consequence data holding unit 16. The trustee collects the lists of these consequences together. This collecting operation is carried out in such a way that, for example, such consequences, the transcription and expressions of which are different from each other, but which indicate the same contents, are collected so as to obtain one consequence. Otherwise, an evaluation operation is carried out by considering the contents of the acquired consequences.

Since an eighth step which is subsequently performed between the trustee and the requester is identical to the eighth step as previously explained in FIG. 11 of the first embodiment, an explanation thereof is omitted.

As previously explained, in the information mining system 1 of the second embodiment, since the analyzer computer 4 is equipped with the analyzing tool 14, workloads given to the process operations of the information mining system 1 can be decreased in addition to the effect of the first embodiment.

Next, an information mining system 1 according to a third embodiment of the present invention will now be described with reference to drawings.

The information mining system 1 of the third embodiment owns the following different points, as compared with these of the first and second embodiments. That is, analyzing tools 14-a and 14-b are provided in an analyzer computer 4 provided on the side of an analyzer. Furthermore, either all or a portion of contents of analyzing-purpose data are held in the analyzer computer 4. It should be noted that the same reference numerals shown in the first, or second embodiment will be employed as those for denoting the structures operable in the same operation manners in the third embodiment, and explanations thereof are omitted.

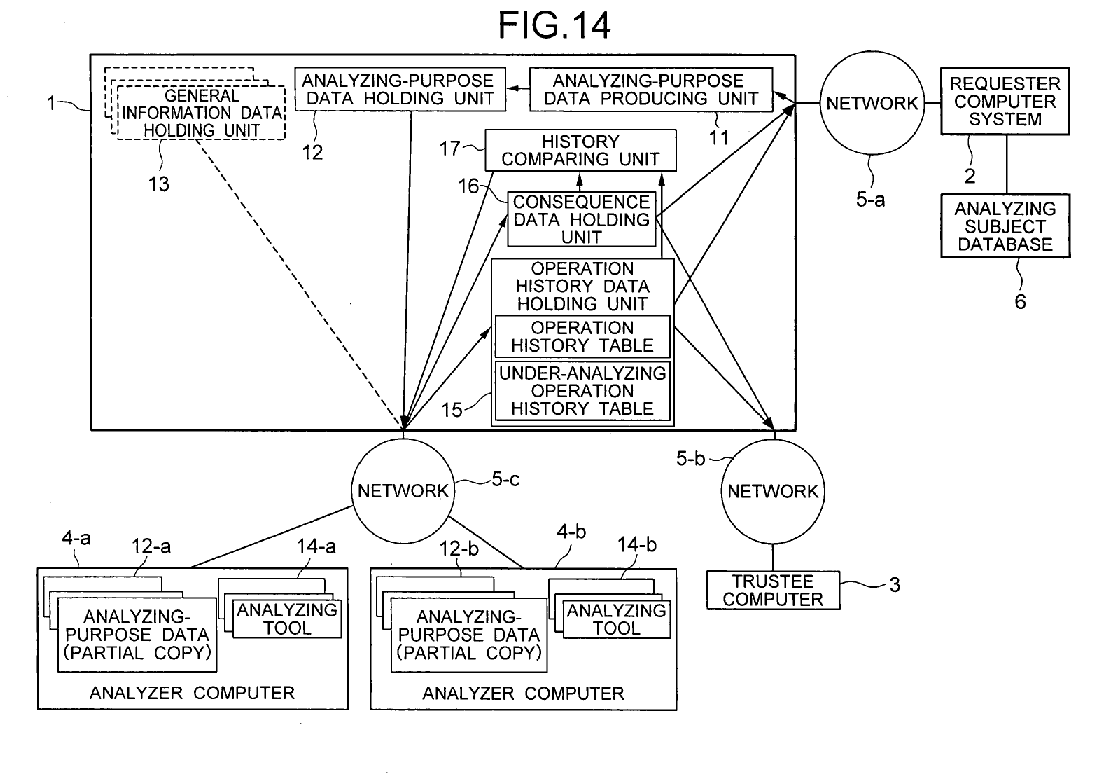

FIG. 14 is a schematic block diagram for indicating an arrangement in which the information mining system 1 of the third embodiment is mainly arranged.

The information mining system 1 is not equipped with an analyzing tool, whereas the analyzing tool 14-a and the analyzing tool 14-b are provided in a computer 4-1 and another computer 4-b of the analyzer, respectively.

It should also be noted that this analyzing tool 14 may be alternatively employed in the analyzer computer 4 from the beginning stage. Alternatively, this analyzing tool 14 may be stored in a storage unit of the information mining system 1, and then, this stored analyzing tool 14 may be downloaded to the analyzer computer 4 when an analysis ID is notified.

Moreover, both an analyzing-purpose data holding unit 12-a and another analyzing-purpose data holding unit 12-b, which correspond to copies of analyzing-purpose data respectively, are provided in the analyzer computers 4-1 and 4-b, respectively. As to this data, when an analyzer commences an analyzing operation, the analyzer refers to an outline of analyzing-purpose data which is transmitted from the information mining system 1 in combination with an analysis ID, and the analyzer (otherwise, analyzer computer 4) determines that which data portion (range) of the analyzing-purpose data is received so as to be held. The analyzer computer 4 notifies the information as to the determined range of the analyzing data with respect to the information mining system 1. The information mining system 1 receives the information as to the range of the analyzing-purpose data transmitted from the analyzer computer 4, and then, sends analyzing-purpose data of the relevant range from the analyzing-purpose data holding unit 12 with respect to the analyzer computer 4. Alternatively, the information mining system 1 may previously determine a range of analyzing-purpose data every analyzer computer 4, and may send the analyzing-purpose data of the respective ranges with respect to the analyzer computer 4. Also, each of the analyzer computers 4 may have all of the ranges for the analyzing-purpose data.

Next, operations of the information mining system 1 of the third embodiment will now be described, while the operations are subdivided into 8 steps as previously explained in FIG. 2.

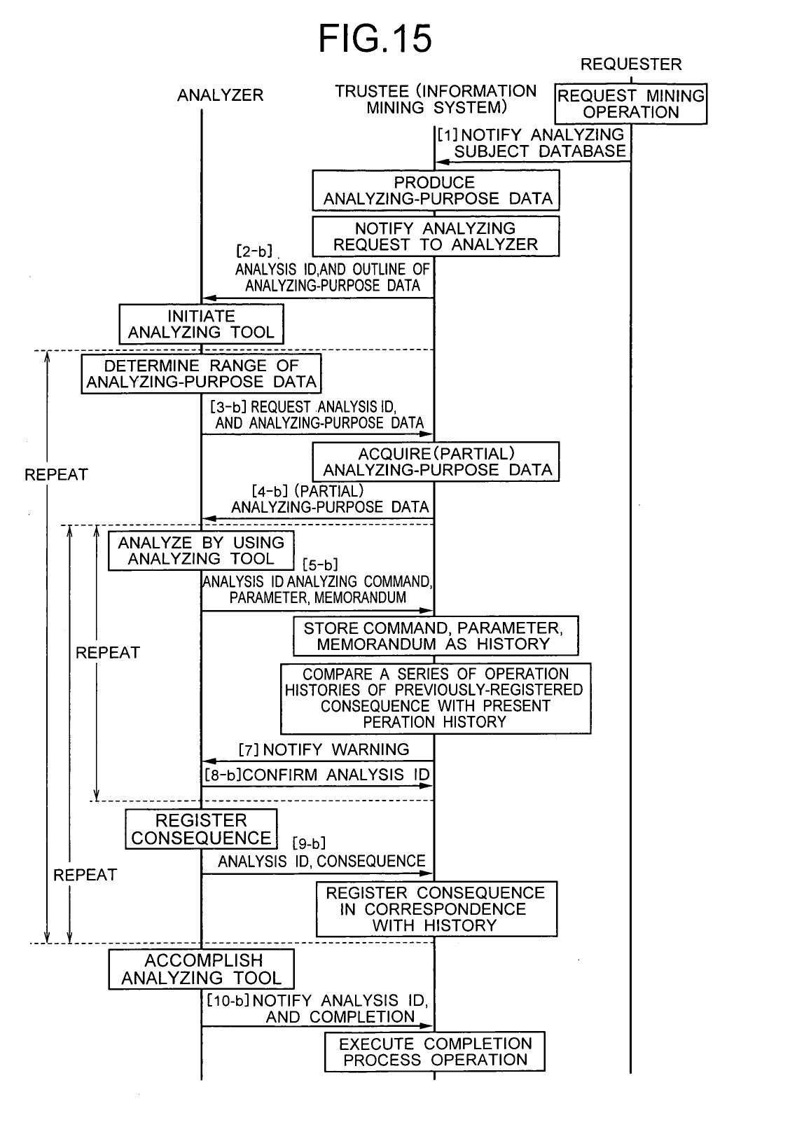

FIG. 15 is a sequential diagram for indicating process operations of the information mining system 1 according to the third embodiment.

Similar to the process operation as explained in FIG. 2, it should be noted that a trustee corresponds to a manager of this information mining system 1, and both the trustee and the information mining system 1 are indicated by a single symbol.

First, in a first step, a requester requests the trustee of the information mining system 1 to perform a data mining operation so as to trust the data mining operation.

Next, in a second step, the requester notifies information as to data stored in the analyzing subject database 6 with respect to the trustee, is connectable to the analyzing subject database 6 from the information mining system 1 (sequence 1), and transfers a data content of the analyzing subject database 6 via the network 5-a to the information mining system 1. Also, in the case that a transfer operation of data cannot be allowed, a connection to the analyzing subject database 6 from the information mining system 1 is established via the network 5-a under control of the requester, so that the requester can access the analyzing subject data. It should also be noted that analyzing subject data recorded on a recording medium may be sent/received from the requester to the trustee.

Next, in a third step, the analyzing subject data of the analyzing subject database 6 is converted into such a data format usable by the analyzing tool 14 by the analyzing-purpose data producing unit 11 of the information mining system 1, and analyzing-purpose data is produced, and then is held in the analyzing-purpose data holding unit 12.

Next, in a fourth step, the trustee notifies an analysis ID (namely, information related to access to analyzing tool 14, for instance, user ID for using analyzing tool 14), and also, an outline of the analyzing-purpose data to a plurality of analyzers (analyzer computers 4), and requests a mining operation of the analyzing-purpose data to these plural analyzers (sequence 2-b). The outline of this analyzing-purpose data corresponds to the outline of the analyzing-purpose data which has been held in the analyzing-purpose data holding unit 12.

The analyzer (or analyzer computer 4) determines that which portion (which range) of the analyzing-purpose data is received to be held based upon the outline of the received analyzing-purpose data, and then, requests information as to the determined range of the analyzing-purpose data with respect to the information mining system 1 (sequence 3-b). It should also be noted that a plurality of analyzers (plural analyzer computers 4) need not be always employed.

The information mining system 1 receives the information as to the range of the analyzing-purpose data transmitted from the analyzer computer 4, and transmits analyzing-purpose data of the corresponding range from the analyzing data holding unit 12 with respect to the analyzer computer 4 (sequence 4-b).

Next, in a fifth step, the analyzer who has received the mining request of the analyzing data initiates the analyzing tool 14 in the analyzer computer 14, and inputs an analyzing ID as a log-in command with respect to the analyzing tool 14, and thus, logs in the analyzing tool 14. Since the analyzing ID is inputted, the analyzing tool 14 may be utilized, and then, the analyzer can start an analyzing operation of such a data which is held in the analyzing-purpose data holding unit 12-a, or 12-b.

The analyzing tool 14 refers to the analyzing-purpose data which has been held in the analyzer computer 4. Each of the analyzers browses (refers) the analyzing data, frames a certain hypothesis, and verifies the hypothesis by using the analyzing tool 14. In this case, the analyzer may electronically write a memorandum in a memorandum column of the analyzing tool 14 and may record this memorandum. This memorandum is sequentially recorded via the network 5-c in the operation history data holding unit 15 of the information mining system 1 in combination with a history of process operations executed by the analyzing tool 14. Furthermore, a result of the verification of the hypothesis and a comment may be written into the memorandum column so as to be recorded. For instance, in the case that the verification of the hypothesis succeeds and certain useful knowledge is obtained, this useful knowledge is registered. In the case that the verification of the hypothesis fails, this failure is registered. When the analyzer gives up the execution of the verification, this fact is registered (sequences 5-b and 9-b).

It should also be noted that when the analyzing tool 14 transmits and receives data, a memorandum, and information as to a hypothesis between the own analyzing tool 14 and the information mining system 1, this analyzing tool 14 transmits these data and information in combination with the analysis ID notified in the fourth step 4. Based upon this analysis ID, the information mining system 1 can recognize that which analyzer performs the analyzing operation.

While an analyzer performs an analyzing work, a history of operation which the analyzer has performed with respect to the analyzing tool 14 is sequentially recorded via the network 5-c on the operation history data holding unit 15 of the information mining system 1 with respect to each of the analyzers every time the analyzing process operation is carried out. Also, in such a case that an analyzer instructs to register as a consequence such a memorandum into which a result of verification of a hypothesis has been written, this memorandum becomes a “consequence.” The analyzing tool 14 records via the network 5-c a content of a consequence in the consequence data holding unit 16 of the information mining system 1 in correspondence with an operation history of a series of verification by which this consequence could be obtained.

It should be understood that until the registering operation of the consequence is carried out, the operation history obtained under analyzing operation is temporarily stored in the under-analyzing operation history table of the operation history data holding unit 15. Then, when the consequence is registered, the operation history is recorded in the operation history table of the operation history data holding unit 15 in correspondence with the consequence. When the consequence is recorded in the operation history table, the operation history corresponding to this consequence is deleted from the under-analyzing operation history table. In other words, the operation history is moved.

Next, in a sixth step, every time an operation history is added which has been performed by the analyzer under analyzing operation and is transmitted via the network 5-c, the information mining system 1 is operated in such a manner that the history comparing unit 17 compares the operation history related to the present analysis by the analyzer with the past operation history recorded in the operation history table. In such a case that the history comparing unit 17 judges that there is a high resemblance degree between the operation history of the analyzer under analyzing operation and an operation history (otherwise, a portion of this operation history) corresponding to such a consequence which has been registered by another analyzer (otherwise, analysis performed by own analyzer in past), the history comparing unit 17 notifies warning via the network 5-c with respect to the analyzing tool 14 (analyzer computer 4 of analyzer himself), and further, displays a list of consequences and memorandums, which correspond to the operation history whose resemblance degree is high (sequence 7). An analyzer who has received this warning executes a confirmation operation with respect to the warning (sequence 8-b).

When the analyzer confirms the list, and then, the consequence with respect to the hypothesis framed by the own analyzer has already been acquired by another analyzer (otherwise, analysis result which was obtained in past by himself), this analyzer may interrupt the mining work in order to avoid the repetitive search.

Also, even in such a case that a consequence has already been acquired, an analyzer may continue to execute a work. This is because there is the below-mentioned possibility. That is, even if the operation histories up to such a time instant when the operation histories are shown are resembled to each other, there is such a possibility that another consequence may be obtained in a succeeding analyzing operation, which is different from the previous consequence, and/or this analyzer may find out an event which may conduct that new knowledge is found out. In this case, assuming now that the same consequences are finally obtained, although values thereof are low in view of a variety of information mining operations, the same consequences may constitute such information capable of reinforcing a certainty of the consequences. A judgement of a resemblance degree by this history comparing unit 17 may be carried out by expressing a resemblance characteristic of an analysis subject, a resemblance characteristic of an analysis condition (retrieve keyword and numeral value), and resemblance characteristic of operations and operation flows by numeral values.

The above-described fifth step and sixth step are repeatedly carried out. Then, in a seventh step, in such a case that a predetermined constant time period (for example, delivery deadline designated by requester) has elapsed, or a preselected number of consequences (for example, results obtained based upon cost designated by requester) can be obtained, the analyzer accomplishes the analyzing operation, and performs a log-out process operation from the analyzing tool 14. Either this log-out process operation by the analyzer or the notification of the completion issued from the analyzer is transferred from the analyzing tool 14 via the network 5-c to the information mining system 1, so that a series of the analyzing process operations is ended (sequence 10-b). It should also be noted that in view of a security aspect, it is preferable to discard the analyzing-purpose data held in the analyzer computer 4 when the analyzing tool 14 is accomplished.

Then, the trustee acquires the lists of the consequences in which the analysis results of the analyzer are reported from the consequence data holding unit 16. The trustee collects the lists of these consequences together. This collecting operation is carried out in such a way that, for example, such consequences, the transcription and expressions of which are different from each other, but which indicate the same contents, are collected so as to obtain one consequence. Otherwise, an evaluation operation is carried out by considering the contents of the acquired consequences.

Since an eighth step which is subsequently performed between the trustee and the requester is identical to the eighth step as previously explained in FIG. 11 of the first embodiment, an explanation thereof is omitted.

As previously explained, in the information mining system of the third embodiment, since the analyzer computer 4 holds at least a portion of the content of the analyzing-purpose data, a total amount of data which is transmitted and received via the network (network 5-c) can be reduced, and also, the traffic of the network can be lowered in addition to the effects achieved by the first and second embodiments, so that the efficiency of the overall process operation as to the information mining system 1 can be increased.

The information mining system, according to the present invention, is comprised of: the consequence data holding unit, the operation history data holding unit, and the history comparing unit. The consequence data holding unit records therein the operation histories of the analyzing tools, which have been executed by the respective terminals used by the plural analyzers while these plural analyzers execute the mining operations at the same time in the parallel mode, and the consequences obtained in the analyzing operations in correspondence with these operation histories. The operation history data holding unit records therein a series of operation histories of the analyzing tools which are being executed by the plural terminals under analyzing operation. The history comparing unit judges as to whether at least a portion of the content held in the consequence data holding unit is made coincident with, or is resembled to the content held in the operation history data holding unit. In such a case that the history comparing unit judges that the content of the consequence data holding unit is made coincident with, or is resembled to the content of the operation history data holding unit, this history comparing unit issues the notification with respect to the analyzing tools operated under analyzing operation. As a result, it is possible to avoid that the plural analyzers perform the repetitive searches. Also, since such a means is employed which is capable of referring to the list of the consequences which have already been acquired by other analyzers and also the history information thereof when the warning is produced, the analyzers can find out various knowledge in the higher efficiency. In addition, since the history comparing unit compares the consequences with the operation histories, there is such an effect that the evaluation work of the consequences can be carried out in the higher efficiency.

It should be further understood by those skilled in the art that although the foregoing description has been made on embodiments of the invention, the invention is not limited thereto and various changes and modifications may be made without departing from the spirit of the invention and the scope of the appended claims.

What is claimed is:

1. An information mining system for analyzing data stored in a database by employing an analyzing tool, comprising:
an operation history data holding unit for recording therein both an operation history of the analyzing tool which was carried out in the past in said analyzing operation, and an operation history of the analyzing tool under analyzing operation; and
a history comparing unit for judging as to whether or not said operation history of the analyzing tool executed in the past is resembled to the operation history of the analyzing tool under analyzing operation, and operated in such a manner that when said history comparing unit judges that the operation history of the analyzing-tool executed in the past is resembled to at least a portion of the operation history of the analyzing tool under analyzing operation, the history comparing unit notifies said partial resemblance of the operation history with respect to the analyzing tool under analyzing operation.

2. An information mining system as claimed in claim 1 wherein:
a terminal equipped with said analyzing tool is connected to the information mining system, into which an operation of said analyzing tool is entered; and
said operation history data holding unit records therein a history of the operation of said analyzing tool entered into said terminal.

3. An information mining system as claimed in claim 2 wherein:
said terminal is comprised of an analyzing-purpose data holding unit for holding therein at least a portion of the data stored in the database; and
said analyzing tool analyzes the data held in said analyzing-purpose data holding unit.

4. An information mining system as claimed in any one of claim 1 wherein:
said information mining system is further comprised of:
a consequence data holding unit for holding therein operation history data in correspondence with such a fact that said operation history data has been recorded in any of the operation histories recorded in said operation history data holding unit.

5. An information mining system as claimed in claim 4 wherein:
said consequence data holding unit records therein a consequence which is obtained by said analyzing operation, and holds a correspondence relationship between said operation history and said consequence; and
in the case that said history comparing unit judges that the recorded content of said operation history data holding unit is resembled to at least a portion of the recorded content of said consequence data holding unit, said history comparing unit notifies such a partial resemblance of the recorded content with respect to the analyzing tool under analyzing operation.

6. An information mining system as claimed in claim 5 wherein:
in the case that said history comparing unit judges that the operation history of the analyzing tool executed in the past is resembled to at least a portion of the operation history of the analyzing tool under analyzing operation, said history comparing unit classifies the consequence which has been recorded in correspondence with said operation history.

7. An information mining system as claimed in claim 6 wherein:
said history comparing unit classifies the recorded content of said consequence data holding unit into a first case that both said consequences and said operation histories are resembled to each other; into a second case that said consequences are not resembled to each other, but said operation histories are resembled to each other; into a third case that said consequences are resembled to each other, and said operation histories are not resembled to each other; and into a fourth case that both the consequences and the operation histories are not resembled to each other.

8. An information mining terminal connected to an information mining system for analyzing data stored in a database by employing an analyzing tool, into which an operation of said analyzing tool is entered, wherein:
in such a case that said information mining system judges that a recorded content of an operation history of the analyzing tool under analyzing operation is resembled to at least a portion of a recorded content of an operation history of the analyzing tool which was carried out in said analyzing operation, said information mining terminal displays said partial resemblance of said recorded contents.

9. An information mining terminal as claimed in claim 8 wherein:
said information mining terminal is comprised of said analyzing tool; and
the analyzing tool analyzes the data stored in the database by employing a calculation resource provided in said information mining terminal.

10. An information mining terminal as claimed in claim 9 wherein:
said information mining terminal is comprised of an analyzing-purpose data holding unit for holding therein at least a portion of said data stored in said database; and
said analyzing tool analyzes the data held in said analyzing-purpose data holding unit.

11. A program for causing an information mining system which analyzes data stored in a database by employing an analyzing tool to analyze said stored data, wherein:
said program causes said information mining system to execute:
a sequence for recording an operation history of an analyzing tool which has been carried out in said analyzing operation, and a consequence obtained by said analyzing operation in correspondence with said operation history;
a sequence for recording an operation history of the analyzing tool under analyzing operation;
a sequence for judging as to whether or not said operation history recorded in correspondence with said consequence is resembled to the operation history under said analyzing operation; and
a sequence executed in such a manner that when such a judgement is made that the operation history recorded in correspondence with said consequence is resembled to at least a portion of the operation history under said analyzing operation, such a partial resemblance of the operation histories is notified with respect to the analyzing tool under said analyzing operation.

12. A program for causing an information mining terminal connected to an information mining system for analyzing data stored in a database by employing an analyzing tool, into which an operation of said analyzing tool is entered, to execute an operation related to an analyzing operation of said stored data;
wherein:
said program causes said information mining terminal to execute:
a sequence executed in such a manner that when said information mining system judges that a recorded content of an operation history of the analyzing tool under analyzing operation is resembled to at least a portion of a recorded content of an operation history of the analyzing tool which was carried out in said analyzing operation, said information mining terminal receives a notification as to said partial resemblance of said recorded contents; and
a sequence executed in such a manner that said partial resemblance is displayed based upon a result of said notification reception.
